(19) United States
(12) Patent Application Publication
(10) Pub. No.: US 2026/0316922 A1
(43) Pub. Date: Oct. 15, 2026

(54) CABIN WINDOW ASSEMBLY FOR AN AIRCRAFT

(71) Applicant: American Honda Motor Co., Inc., Torrance, CA (US)

(72) Inventors: Daniel Lee BOGER, Clemmons, NC (US); Graham F. ROPER, Durham, NC (US); Brett M. SCHOPPA, Summerfiled, NC (US); Nicholas J. DAVIS, Pleasant Gardens, NC (US)

(21) Appl. No.: 19/178,954

(22) Filed: Apr. 15, 2025

(51) Int. Cl. B64C 1/14

(52) U.S. Cl. CPC B64C 1/1492

(57) ABSTRACT

A cabin window assembly for an aircraft includes a retainer ring attached to a fuselage of the aircraft. The retainer ring defines an opening. A window is received within the opening of the retainer ring. Retention clips are releasably connected to the retainer ring and spaced about a peripheral edge portion of the retainer ring. Fastening members releasably connect the retention clips to the retainer ring, wherein removal of the fastener members from the retainer ring and the retention clips allows for removal of the window from the retainer ring without detaching the retainer ring from the fuselage. When the retention clips are connected to the retainer ring, each retention clip is pressed against the window such that a deflection of each retention clip via engagement with the window provides a predetermined preload on the window.

### BACKGROUND

Aircraft windows are generally secured by a window frame which is attached to structural members (i.e., fuselage) of the aircraft. The window frame generally includes mounting members that engage the window as the window is pushed against the window frame. The mounting members are typically part of the window frame. Therefore, with the known design, the entire window frame has to be removed to replace the window.

### BRIEF DESCRIPTION

According to one aspect, a cabin window assembly for an aircraft comprises a retainer ring attached to a fuselage of the aircraft. The retainer ring defines an opening. A window is received within the opening of the retainer ring. Retention clips are releasably connected to the retainer ring and spaced about a peripheral edge portion of the retainer ring. Fastening members releasably connect the retention clips to the retainer ring, wherein removal of the fastener members from the retainer ring and the retention clips allows for removal of the window from the retainer ring without detaching the retainer ring from the fuselage. When the retention clips are connected to the retainer ring, each retention clip is pressed against the window such that a deflection of each retention clip via engagement with the window provides a predetermined preload on the window.

According to another aspect, a cabin window assembly for an aircraft comprises a retainer ring attached to a fuselage of the aircraft. The retainer ring defines an opening. A window is received within the opening of the retainer ring. Retention clips are releasably connected to the retainer ring and spaced about a peripheral edge portion of the retainer ring. Nuts are secured to the retainer ring beneath the retention clips. Threaded fasteners attach the retention clips to the retainer ring via engagement with the nuts. Removal of the threaded fasteners from the retainer ring allows for removal of the window from the retainer ring without detaching the retainer ring from the fuselage.

According to another aspect, a method of assembling a cabin window to a fuselage of an aircraft comprises attaching a retainer ring to a fuselage of the aircraft, the retainer ring defining an opening; positioning a window within the opening of the retainer ring; positioning retention clips about a peripheral edge portion of the retainer ring and engaging the window with the retention clips; and fastening the retention clips to the retainer ring with fasteners and applying a predetermined fastening torque to the fasteners so that the retention clips provide a predetermined preload on the window.

### BRIEF DESCRIPTION OF THE DRAWINGS

FIG. 1 is a partial perspective view of a cabin window assembly including a retainer assembly for attachment to an inner surface of a fuselage of an aircraft according to one aspect of the present disclosure.

FIG. 2 is a cross-sectional view of FIG. 1.

FIG. 3 is a perspective view of a retainer ring of the retainer assembly of FIG. 1.

FIG. 4 is a partial cross-sectional view of FIG. 3.

FIG. 5 is a partial perspective view of a cabin window assembly including a retainer assembly for attachment to the inner surface of the fuselage according to another aspect of the present disclosure.

FIG. 6 is a perspective view of a retainer ring of the retainer assembly of FIG. 5.

FIG. 7 is a partial cross-sectional view of FIG. 6.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Further, any term of degree used herein, such as “substantially”, means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

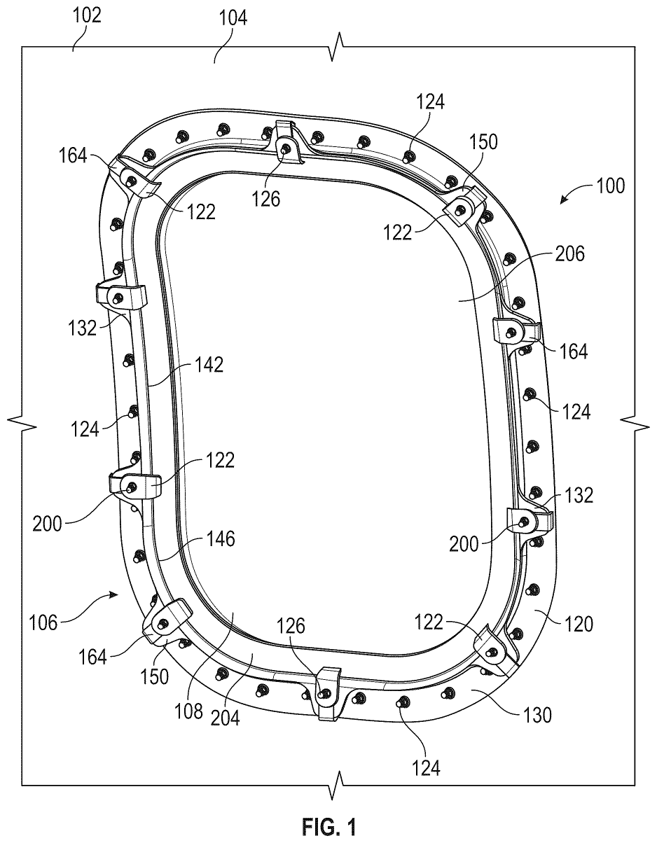

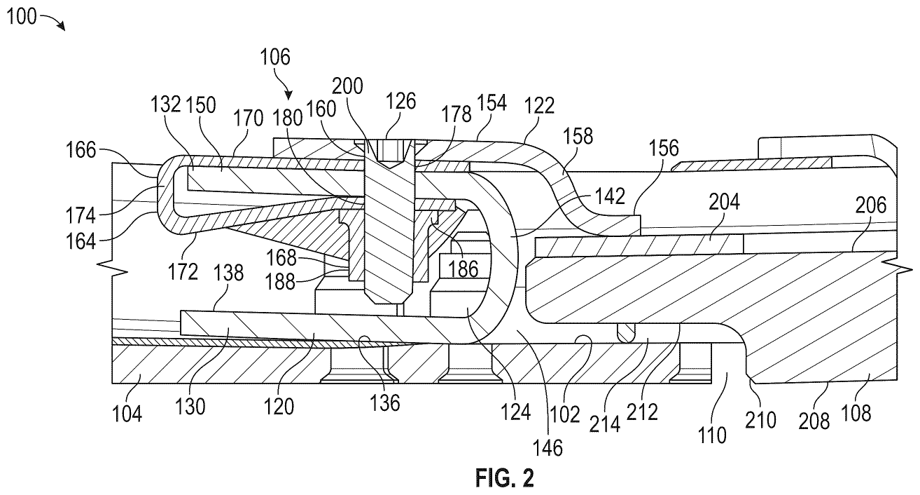

Referring now to the drawings, wherein like numerals refer to like parts throughout the several views, FIGS. 1 and 2 illustrate a cabin window assembly 100 for attachment to an inner surface 102 of a fuselage 104 of an aircraft according to one aspect of the present disclosure. The cabin window assembly 100 generally includes a retainer assembly 106 and a window 108. The window 108 is fitted within an opening or cutout 110 in the fuselage 104. It should be appreciated that although this particular embodiment describes the retainer assembly 106 in connection with, for example, a passenger viewing window of the aircraft, the retainer assembly 106 may equally be applied to other types of aircraft windows.

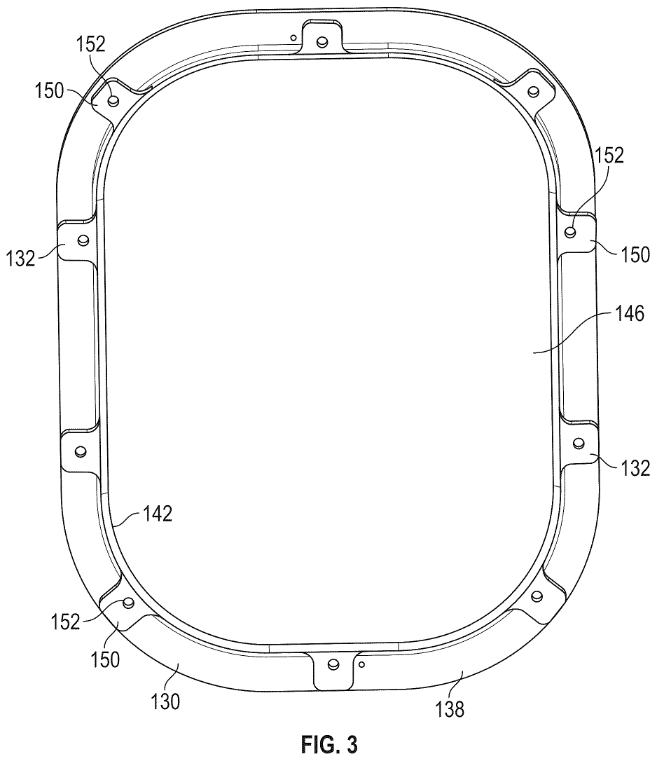

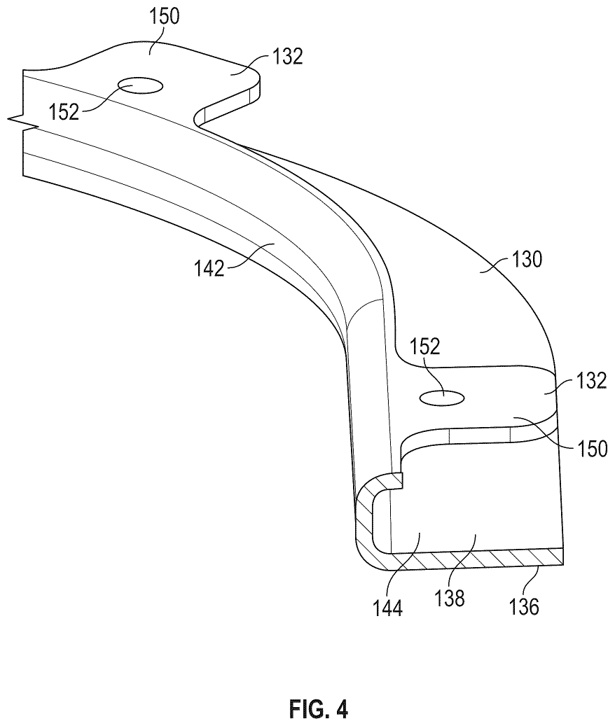

The retainer assembly 106 includes a retainer ring 120, retention clips 122, first fastening members 124 for attaching the retainer ring 120 to the inner surface 102 of the fuselage 104, and second fastening member 126 for attaching the retention clips 122 to the retainer ring 120. The retainer ring 120 is a metallic (e.g., steel or aluminum) or composite window component that is sized to correspond to the cutout 110 in the fuselage 104 for the window 108. With reference to FIGS. 3 and 4, the retainer ring 120 includes a base wall 130 and mounting features 132. The base wall 130 is directly attached to the inner surface 102 of the fuselage 104 via the first fastening members 124. The mounting features 132 are configured to engage with the second fastening members 126. The base wall 130 includes a first surface 136 and a second surface 138 opposite the first surface relative to a thickness direction of the retainer ring 120. The first surface 136 has a design profile shaped to correspond and mate with the inner surface 102 of the fuselage 104. The mounting features 132 are spaced from the second surface in the thickness direction. The retainer ring 120 includes a sidewall 142 extended from the base wall 130 along an inner peripheral edge portion 144. The sidewall 142 follows a peripheral edge of the fuselage 104 that defines the cutout 110. The sidewall 142 defines an opening 146 for receiving the window 108. The mounting features 132 extend from the sidewall 142. In the depicted aspect, the mounting features 132 are mounting tabs 150 having holes 152 for the second fastening members 126. As shown, the retainer ring 120 includes ten mounting tabs 150 spaced substantially symmetrically about the retainer ring 120. In alternative embodiments not shown, a different number of mounting tabs 150 may be provided, and may be distributed symmetrically or asymmetrically about the retainer ring 120.

The retention clips 122 are releasably connected to the retainer ring 120 and spaced about the inner peripheral edge portion 144, specifically the sidewall 142 of the retainer ring 120. The second fastening members 126 releasably connect the retention clips 122 to the mounting tabs 150 of the retainer ring. It should be appreciated that the mounting tabs 150 are sized to prevent the retention clips 122 from rotating thereon when being fastened. In the depicted aspect of FIG. 2, each retention clip 122 is substantially step shaped with a first wall 154, a second wall 156 spaced from the first wall in a height direction of the retention clip, and a side wall 158 interconnecting the first wall and the second wall. The first wall 154 includes a through hole 160 for the second fastening member 126. The second wall 156 engages the window 108.

As will be described below, when the retention clips 122 are connected to the retainer ring 120, each retention clip 122 is pressed against the window 108 such that a deflection of each retention clip via engagement with the window provides a predetermined preload on the window 108. Each mounting tab 150 is spaced a predetermined distance from the base wall 130 of the retainer ring 120 and the window 108 allowing for each retention clip 122 when fastened to the retainer ring 120 to provide the predetermined preload on the window. And to maintain seal of the window 108 to the inner surface 102 of the fuselage 104, a total preload on the window 108 provided by the retention clips 122 exceeds a predetermined pressure. In the present embodiment, the preload provided by each clip is approximately 18 lbs to approximately 21 lbs; however, the specific preload needed by each retention clip 122 so that the total preload on the window 108 via the retention clips 122 exceeds the predetermined pressure is determined by the aircraft type and design. Further, the retention clips 122 allow for the removal of the window 108 from the retainer ring 120 without detaching the retainer ring 120 from the fuselage 104. By simply removing the second fastening members 126 from the retainer ring 120 and the retention clips 122, the window 108 can be easily removed and replaced if damaged.

With reference back to FIG. 2, the second fastening members 126 include clip nuts 164 secured directly to the mounting tabs 150 of the retainer ring 120. Each clip nut 164 includes a clip body 166 and a nut member 168. The clip body 166 comprises a first arm portion 170 connected to a second arm portion 172 by an end wall or bight portion 174. The first arm portion 170 and the second arm portion 172 include respective through holes 178 and 180. The nut member 168 includes a base 186 affixed to the second arm member 172 and an annular member 188 extended from the base. The annular member 188 is provided with internal threads (not shown). The second fastening members 126 further include threaded fasteners 200 attaching the retention clips 122 to the clip nuts 164. The clip nuts 164 are directly connected to the retainer ring 120 with the retention clips 122 secured above the clip nuts. Each threaded fastener 200 extends through the hole 160 in the retention clip 122, the through hole 178 in the first arm portion 170 of the clip nut 164, the hole 152 in the mounting tab 150, the through hole 180 in the second arm portion 172 of the clip nut 164, and threadingly engages the internal thread of the nut member 168. When fastened to the clip nuts 164 each threaded fastener 200 has a predetermined fastening torque to provide the predetermined preload on the window by the retention clip 122. In the present embodiment, the fastening torque of each threaded fastener 200 is approximately 5 in-lbs to approximately 7 in-lbs; however, the specific fastening torque needed to achieve the specific preload provided by each retention clip 122 is determined by the aircraft. It should be appreciated that the clip nuts 164 are one manner for attaching the retention clips 122 to the mounting tabs 150, and that alterative nuts can be used. It should also be appreciated that in lieu of the clip nuts, the holes 152 in the mounting tabs 150 can be threaded.

In FIG. 2, a clamp ring 204 is secured to a first or inside surface 206 of the window 108, and the retention clips 122 directly engage the clamp ring. This prevents damage to the window surface from the retention clips 122. A second or outside surface 208 of the window 108 opposite the first surface 206 can include a chamfer 210 to improve resistance to chipping; although, this is not required. An edge section 212 of the window opposite the clamp ring 204 has a reduced thickness as compared to the remainder of the window. A seal 214 (e.g., a bulb seal or pressure seal) is provided on the edge section 212. The seal 214 engages the inner surface 102 of the fuselage 104 to create a pressure boundary.

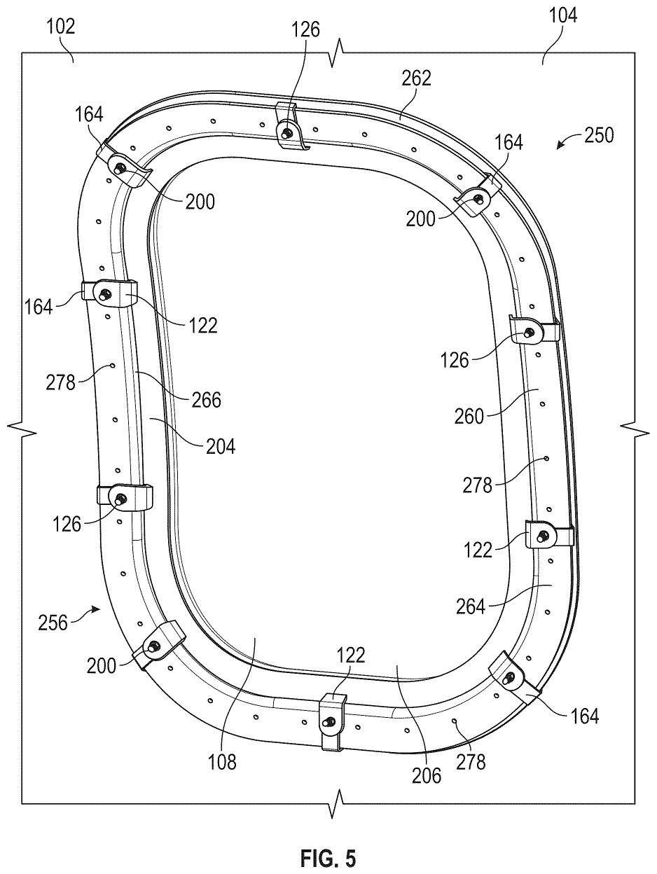

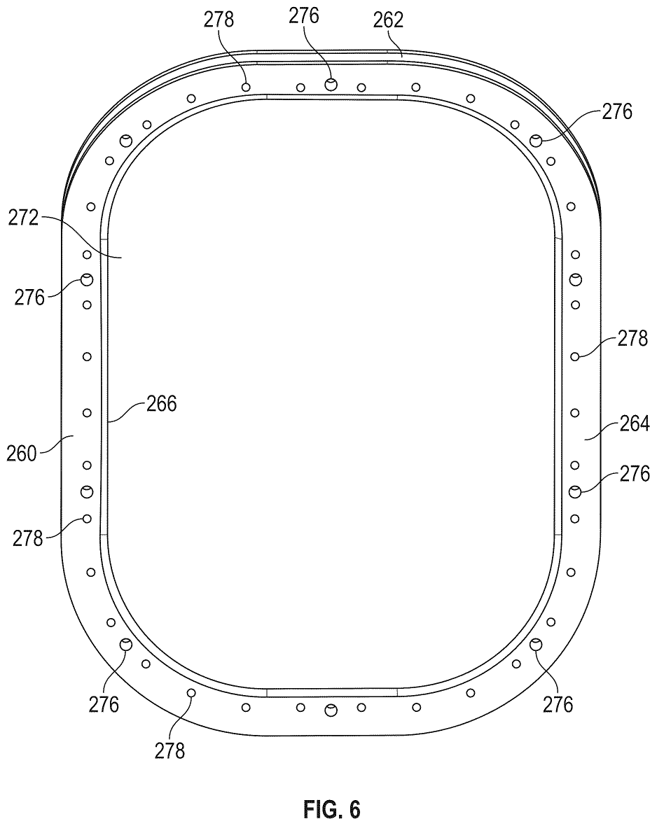

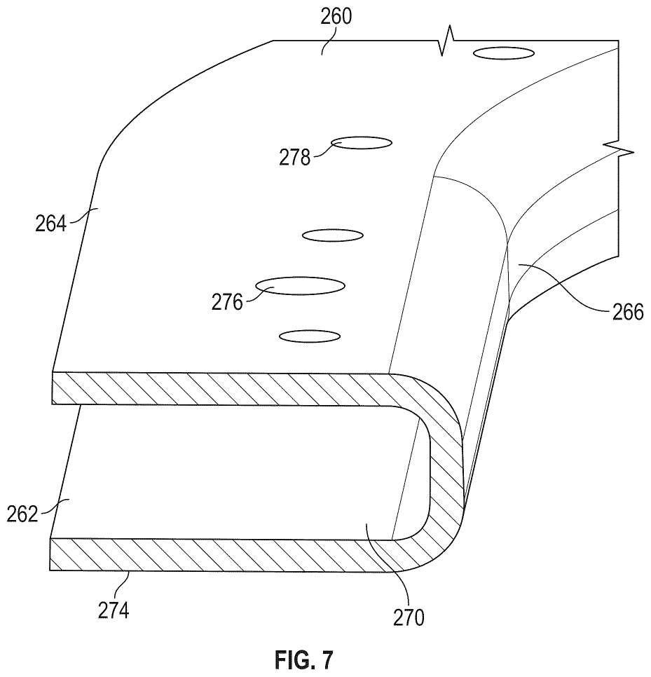

FIGS. 5-7 illustrate a cabin window assembly 250 for attachment to the inner surface 102 of the fuselage 104 according to another aspect of the present disclosure. The cabin window assembly 250 generally includes a retainer assembly 256 and the window 108. The retainer assembly 256 includes a retainer ring 260, the retention clips 122, the first fastening members 124 (not visible) for attaching the retainer ring 260 to the inner surface 102 of the fuselage 104, and the second fastening member 126 for attaching the retention clips 122 to the retainer ring 260. The retainer ring 260 includes a first wall 262 and a second wall 264 spaced from the first wall in a thickness direction of the retainer ring. A sidewall 266 interconnects the first and second walls 262, 264 along an inner peripheral edge portion 270. The sidewall 266 defines an opening 272 for the window 108. As depicted, the retainer ring 260 has a substantially c-shape in cross-section. A surface 274 of the first wall 262 has a design profile shaped to correspond and mate with the inner surface 102 of the fuselage 104. The second wall 264 includes first openings 276 for the second fastening members 126 and second openings 278. The second openings 278 in the second wall 264 provide access to the first fastening members 124 from above the second wall 264. Therefore, the second openings 278 are tool access openings that allow for the ease of attaching and detaching of the retainer ring 260 via the first fastening members.

The retention clips 122 are spaced about the inner peripheral edge portion 270 of the retainer ring 260. As shown, the retainer ring 260 includes ten retention clips 122 fastened to the second wall 264 and spaced substantially symmetrically about the retainer ring 260. In alternative embodiments not shown, a different number of retention clips 122 may be provided, and may be distributed symmetrically or asymmetrically about the retainer ring 260. The second fastening members 126 releasably connect the retention clips 122 to the second wall 264 of the retainer ring 260. Again, when the retention clips 122 are connected to the retainer ring 260 each retention clip 122 is pressed against the window 108 such that a deflection of each retention clip 122 via engagement with the window 108 provides a predetermined preload on the window. Further, removal of the second fastening members 126 releasably from the retainer ring 260 and the retention clips 122 allow for removal of the window 108 from the retainer ring 260 without detaching the retainer ring 260 from the fuselage 104.

With reference to FIG. 5, the clip nuts 164 of the second fastening members 126 are directly connected to the second wall 264 of the retainer ring 260 with the retention clips 122 secured above the clip nuts. Each threaded fastener 200 of the second fastening members 126 extends through the hole in the retention clip 122, the hole in the first arm portion of the clip nut 164, the first opening 276 in the second wall 264, the hole in the second arm portion of the clip nut 164, and threadingly engages the internal thread of the nut member. It should be appreciated the clip nuts 164 are one manner for attaching the retention clips 122 to the second wall 264 of the retainer ring 260, and that alterative nuts can be used. It should also be appreciated that in lieu of the clip nuts, the first opening 276 can be threaded. The retention clips 122 engage the clamp ring 204 secured to the first surface 206 of the window 108.

As is evident from the foregoing, a method of assembling the cabin window 108 to the fuselage 104 of the aircraft is provided. The exemplary method generally comprises attaching the retainer ring 120, 260 to the inner surface 102 of the fuselage 104, the retainer ring defining the opening 146, 272; positioning the window 108 within the opening of the retainer ring 120, 260; positioning the retention clips 122 about a peripheral edge portion 144, 270 of the retainer ring 120, 260 and engaging the window 108 with the retention clips 122; and fastening the retention clips 122 to the retainer ring 120, 260 with fasteners 200 and applying a predetermined fastening torque to the fasteners so that the retention clips 122 provide a predetermined preload on the window.

The exemplary method includes securing the clip nuts 164 directly to the retainer ring 120, 260 and attaching the retention clips 122 to the clip nuts via the fasteners 200. As indicated, according to one aspect, the retainer ring 260 includes the first wall 262 and the second wall 264, and the method includes attaching the first wall 262 to the fuselage 104 with additional fasteners 124, fastening the retention clips 122 to the second wall 264, and accessing the additional fasteners 124 through the second openings 278 provided in the second wall. As indicated, the window 108 is removable from the retainer ring 120, 260 without detaching the retainer ring from the fuselage 104.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A cabin window assembly for an aircraft comprising:
a retainer ring attached to a fuselage of the aircraft, the retainer ring defining an opening;
a window received within the opening of the retainer ring;
retention clips releasably connected to the retainer ring and spaced about a peripheral edge portion of the retainer ring; and
fastening members releasably connecting the retention clips to the retainer ring, wherein removal of the fastener members from the retainer ring and the retention clips allows for removal of the window from the retainer ring without detaching the retainer ring from the fuselage,
wherein when the retention clips are connected to the retainer ring, each retention clip is pressed against the window such that a deflection of each retention clip via engagement with the window provides a predetermined preload on the window.

2. The assembly of claim 1, wherein the retainer ring includes a base wall and mounting tabs spaced above the base wall, each mounting tab configured to receive one of the retention clips and one of the fastening members.

3. The assembly of claim 2, wherein each mounting tab is spaced a predetermined distance from the window allowing for each retention clip when fastened to the retainer ring to provide the predetermined preload on the window.

4. The assembly of claim 1, wherein the fastening members include threaded fasteners attaching the retention clips to the retainer ring.

5. The assembly of claim 4, wherein the fastening members further include clip nuts directly connected to the retainer ring with the retention clips secured above the clip nuts, the threaded fasteners attaching the retention clips to the clip nuts.

6. The assembly of claim 4, wherein when the threaded fasteners are fastened to the retainer ring, each threaded fastener has a predetermined fastening torque to provide the predetermined preload on the window via the deflection of the retention clip.

7. The assembly of claim 1, where the retainer ring has a first wall and a second wall spaced from the first wall in a thickness direction of the retainer ring, the first wall secured to the fuselage, the fastening members attaching the retention clips to the second wall.

8. The assembly of claim 7, wherein the second wall includes first openings for the fastening members and second openings providing access to additional fasteners which directly attach the first wall to the fuselage.

9. The assembly of claim 7, wherein the fastening members include clip nuts, the clip nuts directly connected to the second wall.

10. The assembly of claim 1, including a clamp ring secured to a surface of the window, the retention clips directly engaging the clamp ring.

11. A cabin window assembly for an aircraft comprising:
a retainer ring attached to a fuselage of the aircraft, the retainer ring defining an opening;
a window received within the opening of the retainer ring;
retention clips releasably connected to the retainer ring and spaced about a peripheral edge portion of the retainer ring;
nuts secured to the retainer ring beneath the retention clips; and
threaded fasteners releasably attaching the retention clips to the retainer ring via engagement with the nuts,
wherein removal of the threaded fasteners from the retainer ring allows for removal of the window from the retainer ring without detaching the retainer ring from the fuselage.

12. The assembly of claim 11, wherein when connected to the retainer ring each retention clip is pressed against the window, and a deflection of each retention clip via engagement with the window provides a predetermined preload on the window.

13. The assembly of claim 12, wherein when fastened to the retainer ring each threaded fastener has a predetermined fastening torque to provide the predetermined preload on the window.

14. The assembly of claim 11, wherein the retainer ring includes a base wall and mounting tabs spaced above the base wall, each mounting tab configured to receive one of the retention clips.

15. The assembly of claim 11, where the retainer ring has a first wall and a second wall spaced from the first wall in a thickness direction of the retainer ring, the retention clips attached to the first wall.

16. The assembly of claim 15, wherein the first wall includes first openings for the threaded fasteners and second openings providing access to additional fasteners which directly attach the second wall to the fuselage.

17. A method of assembling a cabin window to a fuselage of an aircraft comprising:
attaching a retainer ring to a fuselage of the aircraft, the retainer ring defining an opening;
positioning a window within the opening of the retainer ring;
positioning retention clips about a peripheral edge portion of the retainer ring and engaging the window with the retention clips; and
fastening the retention clips to the retainer ring with fasteners and applying a predetermined fastening torque to the fasteners so that the retention clips provide a predetermined preload on the window.

18. The method of claim 17, including securing clip nuts directly to the retainer ring and attaching the retention clips to the clip nuts via the fasteners.

19. The method of claim 17, wherein the retainer ring includes a first wall and a second wall spaced from the first wall in a thickness direction of the retainer ring, and including attaching the first wall to the fuselage with additional fasteners, fastening the retention clips to the second wall, and accessing the additional fasteners through openings provided in the second wall.

20. The method of claim 17, wherein the window is removable from the retainer ring without detaching the retainer ring from the fuselage.
